(19) United States
(12) Patent Application Publication
(10) Pub. No.: US 2014/0089141 A1
(43) Pub. Date: Mar. 27, 2014

(54) SEARCHING IN AN ON-LINE TRADING SYSTEM

(71) Applicants: Janne Savukoski, Helsinki (FI); Juha Koponen, Helsinki (FI)

(72) Inventors: Janne Savukoski, Helsinki (FI); Juha Koponen, Helsinki (FI)

(73) Assignee: NET-CYCLER OY, Espoo (FI)

(21) Appl. No.: 14/005,309

(22) PCT Filed: Mar. 16, 2011
(86) PCT No.: PCT/EP2011/054004

§ 371 Date: Nov. 27, 2013

(51) Int. Cl. G06Q 30/06

(52) U.S. Cl. CPC G06Q 30/0619
USPC 705/26.44

(57) ABSTRACT

A method of identifying potential trades within a database holding details of individuals and items that these individuals are willing to give away, “Haves”, and/or to receive, “Wants”. The database is searched to identify matching Haves and Wants and to define a directed edge linking the each match. An edge weight can be determined for the directed edge defined for each match and, for one of said individuals possessing a Have, identifying potential n-way trades for the individual by identifying a directed edge or directed edges originating at the individual's Have and/or by connecting two or more directed edges including at least a directed edge originating at the individual's Have, where n is an integer greater than 1. A trade weight is determined on the basis of the or each associated link weight and the potential trades ranked according to the respective trade weights.

### TECHNICAL FIELD

The present invention relates to searching in an on-line trading system and in particular, though not necessarily, to searching in an on-line trading system that allows the general public to either sell or exchange personal items and services.

### BACKGROUND

A number of websites have appeared in recent years to facilitate the exchange or bartering of items and services between members of the public. In a two-way barter, two people directly swap their items or services. The problem with two-way bartering is that, particularly for unusual items, it may be difficult for a first party to link up with another party who has exactly what the first party is looking for. The probability of finding a barter partner grows dramatically in a large user base when n-way barters are allowed. In an n-way barter a group of people exchange their “Haves” and “Wants”. Consider for example the case of three users, C1, C2 and C3, who each have their own haves and wants (written here in brackets as (Have, Want)): C1(A,B), C2(B,C) and C3 (C,A). In this case, the exchange can be coordinated to ensure that each user gets what he/she wants. It is estimated based upon sample data that allowing 3-way trades within a large item database increases the probability of a trade, as compared with a 2-way trade, by a factor of 10. Allowing the possibility of 5-way trades increases this probability by a factor of 400.

WO2010015282 describes an on-line trading system which allows the construction of n-way barter chains. The approach uses a categorisation hierarchy for items and services to facilitate easy searching and matching within a database of items. The categories within this hierarchy are at least partially defined by the users themselves.

WO2010112087 describes an iterative approach to identifying barter chains within a database of trades held by an on-line trading system. As a first step, the system returns to the client 2-way trades identified within the database, including matching and non-matching trades (i.e. a matching trade is one where the result matches both the have and the want of the client, whilst a non matching trade is one where only one of the have and the want are matched). The client may then request that the chain be extended with a further trade, such that the service returns matching and non-matching 3-way trades. The process is repeated, adding one trade for each iteration until, for example, the client finds a suitable match or the service reaches a pre-defined chain size limit. The approach relies upon the use of a web-server cloud to search the trade database.

Whilst both WO2010015282 and WO2010112087 tend to focus on searching for matching, closed chains, i.e. finding chains that close the trade between a user's have and that user's want, a perhaps more typical use case involves a person coming to the trading website wishing to see what he/she can get with one item or each of a set of items that the user is willing to give away. For a very large database of trades including users specifying multiple Haves and Wants, and assuming that say up to 5-way trades are allowed, the total number of trade chains is likely to be very high indeed. The results need to be displayed in the user's web browser window, and this is typically achieved by way of a list that grows as results are received from the on-line trading service. Searching all results by manually scrolling through the list is likely to be laborious and in practice impossible. It may be possible to process the results list at the client in order to reorder the results according to some sorting methodology. For example, this could make use of certain specific user preferences, e.g. minimise trade chain length, geographical proximity of users in the chain, etc. However, such an approach may not be possible with standard web browsers which have only limited functionality.

In some cases, the data generated by a search may be so large that it approaches the limits of what a single client computer can efficiently handle. For example, if a user “can get” 100′000 items in a particular trade, it might require in the region of 3 gigabytes of space (excluding images) on the client computer to process the data. In addition, even with fast network connections, data transfer delays associated with such large amounts of data may be significant.

### SUMMARY

According to a first aspect of the present invention there is provided a method of identifying potential trades within a database holding details of individuals and items that these individuals are willing to give away, “Haves”, and/or to receive, “Wants”. The method comprises searching said database to identify matching Haves and Wants and, for each such match, defining a directed edge linking the matched Have to a Have of the individual possessing the matched Want. The method further comprises determining an edge weight for the directed edge defined for each match and, for one of said individuals possessing a Have, identifying potential n-way trades for the individual by identifying a directed edge or directed edges originating at the individual's Have and/or by connecting two or more directed edges including at least a directed edge originating at the individual's Have, where n is an integer greater than 1. Then, for each potential trade, a trade weight is determined on the basis of the or each associated link weight and the potential trades ranked according to the respective trade weights.

According to a second aspect of the present invention there is provided a method of identifying potential trades within a database holding details of individuals and items that these individuals are willing to give away, “Haves”, and/or to receive, “Wants”. The method comprises searching said database to identify matching Wants and Haves and, for each such match, defining a directed edge linking the matched Want to a Want of the individual possessing the matched Have, and determining an edge weight for the directed edge defined for each match. The method further comprises, for one of said individuals possessing a Want, identifying potential n-way trades for the individual by identifying a directed edge or directed edges originating at the individual's Want and/or by connecting two or more directed edges including at least a directed edge originating at the individual's Want, where n is an integer greater than 1, for each potential trade, determining a trade weight on the basis of the or each associated link weight, and ranking the potential trades according to the respective trade weights.

Embodiments of the above first and second aspect of the invention are able to generate ordered sets of results for user searches, where the ordering is based upon directed edge weights making up a trade chain. This allows results to be ordered based upon a number of desirable trade properties such as the likelihood of a trade completing and revenue for the service operator. Embodiments can simplify the trade selection process for the end users, as well as reducing network traffic and resource use at the user computers.

According to a third aspect of the present invention there is provided a method of presenting a plurality of possible trade results to a user, the results having been generated following the submission of details of a plurality of items by the user to an online trading web service, these submitted items being items that the user is willing to give away. The method comprises displaying within a web browser window presented on a display of a user computer, an ordered set of result images depicting respective items that the user may obtain by trading one of the submitted items, and within each said result image, displaying as an inset an image depicting the submitted item that the user must give away in order to obtain the item displayed in the associated result image.

Embodiments of this third aspect of the invention provide a simple and intuitive graphical user interface for the user, the user being able to see at a glance the Have and Want associated with specific n-way trades.

### BRIEF DESCRIPTION OF THE DRAWINGS

FIG. 1 illustrates a tradable item including an item category and a plurality of sub-categories or properties;

FIG. 2 illustrates a simple database of individuals possessing Haves and Wants, as well as possible trade chains;

FIG. 3 illustrates a Have graph constructed for the database of FIG. 2;

FIG. 4 is a tabulated form of the Have graph of FIG. 3;

FIG. 5 illustrates the database of FIG. 2 updated to include a further user who has defined a Have;

FIG. 6 illustrates a Have graph generated for the updated database of FIG. 5;

FIG. 7 is a tabulated form of the Have graph of FIG. 6;

FIG. 8 illustrates a graphical user interface implemented in a web browser window of a client computer;

FIG. 9 illustrates schematically a network architecture for implementing a trading service over the Internet;

FIG. 10 is a flow diagram showing a process for constructing a searching a database of tradable items;

FIG. 11 shows a Want graph for the scenario of FIG. 2;

FIG. 12 illustrates schematically a further user being added to the database of FIG. 2, that further user specifying only a Want; and

FIG. 13 illustrates schematically the Want graph of FIG. 11 updated to include the further individual of FIG. 12.

### DESCRIPTION

An on-line trading service that allows users to barter items, thereby allowing each user to exchange an item that he or she has (a “Have”) for an item that he or she wants (a “Want”), will typically maintain a database of users and, for each user, that user's Haves and Wants. Such a service will typically consist of one or more web servers hosting a trading website, and associated database servers which respond to queries from the web server(s). Users connect to the Internet using their personal computers and the like, and access the service web pages. Once logged into the service such that their identities are known to the service, users can register their Haves and Wants to determine if matches can be found. They may also ask to be alerted (e.g. by email) if matches are subsequently found (i.e. as a result of items subsequently being entered into the database.

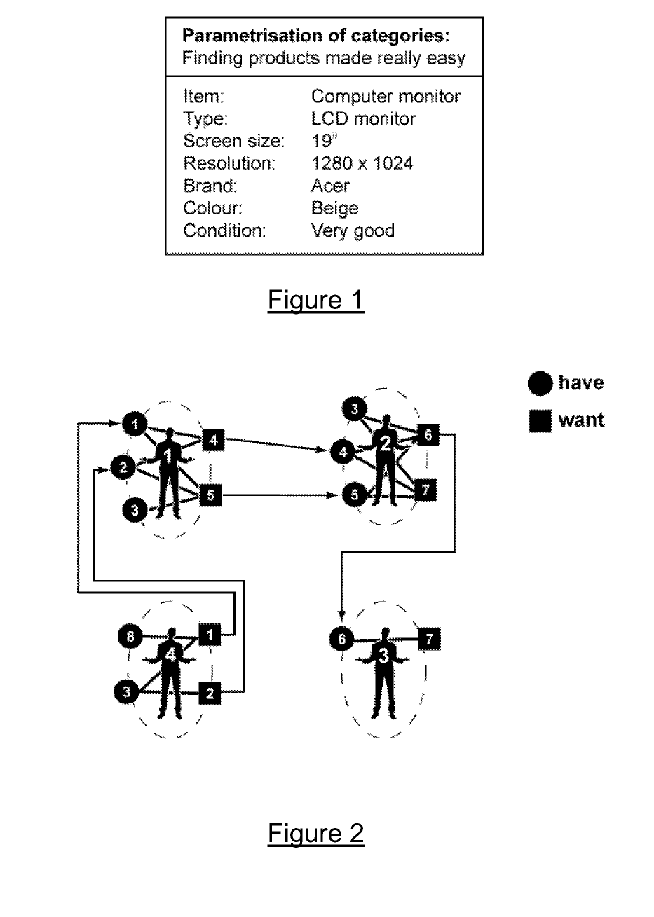

Items recorded in the database are categorised, for example according to a categorisation hierarchy, to facilitate searching of the database. An example classification for a computer monitor is illustrated in FIG. 1. For the purpose of illustration however, in the following discussion only a single layer categorisation approach will be considered, i.e. there is no nesting of categories. In particular, the following eight categories are considered:
1—TV
2—Bed
3—Mobile Phone
4—Chair
5—Bike
6—Digital Camera
7—Table
8—Painting.

FIG. 2 illustrates schematically a set of four users (identified as persons 1 to 4) each of whom has one or more items to trade, where the items are categorised using the eight categories defined above. FIG. 2 is referred to here as a “Have-Want” diagram. [In this example, particular items are only categorised at a top level. Of course, in practice, items are likely to be categorised according to multiple sub-categories, e.g. a television may be a flat screen LCD, plasma screen, CRT, etc). Items may also have parameters associated with them. In the TV example, screen size may be a parameter.] The items that a user has to trade (i.e. which the user possesses) are shown within a circle. It will be apparent that some items are possessed only by a single user, e.g. person 1 is the only person having item 1, whilst other items are possessed by multiple users, e.g. item 3 is possessed by persons 2 and 4. Items that users wish to obtain, i.e. their Wants, are shown in the figure within squares. Again, a given item may be wanted by one or multiple users. The arrows shown in FIG. 2 indicate connections between a Want of a given user and a matching Have of another user. It is noted that a Want of a given user may point to one or many Haves of other users that match the Want. Of course, some Wants may point exactly to one and only one Have, and this is the case with all of the Haves in the example of FIG. 2. [In practice of course, some Wants may not match any Haves, e.g. due to non-matching parameters.]

As is further illustrated in FIG. 2, each person links his or her Wants and Haves, these links being shown as lines within an individual's profile. For example, person 1 is offering a TV 1, Bed 2 and a Mobile phone 3. He wants a chair 4 and a bike 5. He has specified that if he gets the chair 4, he would give away the TV 1 or the bed 2, but not the mobile phone 3, and further that if he gets the bike he would give any of his three items. [In a specific case, the service might not support arbitrarily linking the Haves and Wants of an individual, but instead it could mandate that all of the Haves have to match all the Wants. Alternatively, a number of value categories could be defined by the service with the Haves of an individual being linked only to those Wants of the individual falling within the same value categories.]

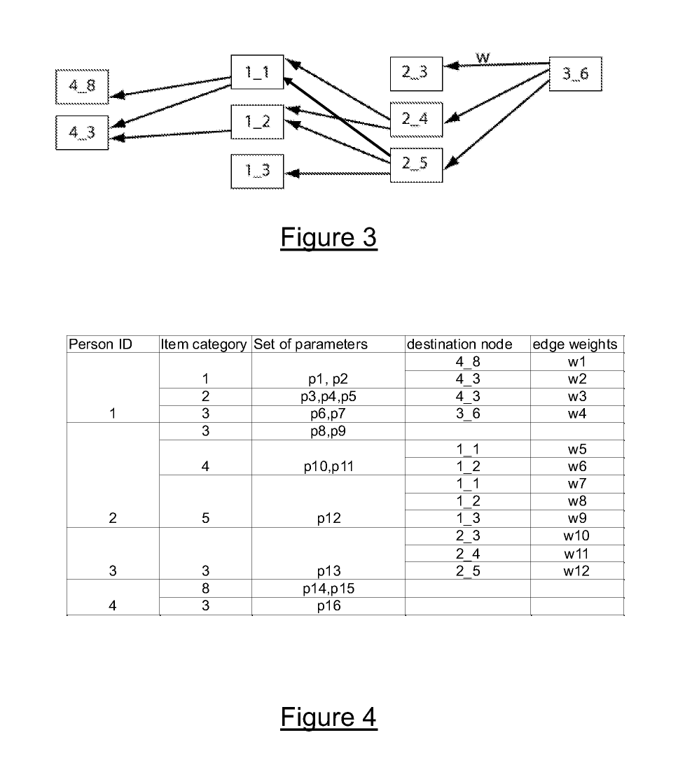

Conceptually, the web trading service takes the Have-Want diagram of FIG. 2 (constructed for all individuals who have registered there Haves and Wants with the service) and uses it to construct a “Have graph”. As will be understood by the skilled person, a “graph” in a mathematical sense is an abstract representation of a set of objects, where each object is illustrated diagrammatically by a vertex of the graph. At least some of the vertices are connected by edges, illustrated diagrammatically by respective lines. FIG. 3 shows a Have graph constructed on the basis of the Have-Want diagram of FIG. 2, where each object (i.e. vertex) corresponds to a Have of one of the individuals registered with the service. The figure uses the terminology (person_item) to uniquely identify an item. So, for example, item (1_1) identifies person 1 and their item 1 (that is the TV offered by person 1).

The presence of an arrow (or “directed edge” using graph terminology) in the graph indicates that, if a particular user gives away an item (corresponding to the source object of the arrow), that can release a further item (corresponding to the destination object of the arrow) for trading. For example, the arrows linking item (1_1) and items (4_8) and (4_3) indicates that if person 1 is able to give up their item 1 (i.e. the TV), then that can release (either of) item 8 (painting) and item 3 (mobile phone) of person 4 for further trading.

It will be appreciated that the graph of FIG. 3 allows a user coming to the service with a Have to identify what items he or she may be able to obtain by trading the Have. For example, suppose a user comes to the service and has item 7 (a table) to offer. The service identifies that user 2 has specified item 7 as a Want. Using the graph (FIG. 3), the service identifies that giving item 7 to user 2 will result in:
items 3, 4 and 5 becoming available (2-way trade);
items 1, 2 and 3 becoming available (3-way trade); and
items 3 and 8 becoming available (4-way trade).

Depending upon the search methodology, these results will be delivered to the client computer of the user in the order in which they are generated. If the approach of WO2010112087 is employed, the 2-way trades will be delivered and displayed first, followed by the 3-way trades, followed by the 4-way trades. For a relatively small database, the total number of results, i.e. available (that is suggested) Haves, may be relatively small, allowing the user to scroll down the list and obtain further details of any items of interest. For a very large database, many thousands or even tens of thousands of Haves may be proposed by the service making it difficult or even impossible for the user to identify items of interest. To mitigate this problem it is proposed to include into the Have graph (e.g. of FIG. 3) a weighting for each directed edge. The weight is very generally indicative of the likelihood that a particular trade will take place.

Considering again the graph of FIG. 3, a weight w is shown for the directed edge between object (3_6) and object (2_3). This indicates the likelihood that person 3 will in reality give away his item 6 (digital camera) to person 2 and that person 2 will give away item 3 (mobile phone), if a complete barter chain including these trades can be established. The weight may be calculated based upon properties including the nature of the items, static properties of the users (in this case persons 2 and 3) such as their geographic location, and the trading histories of these users. For example, the weight w may be determined on the basis of one or more of the following:
Characteristics, preferences and previous history of person 3 (for example whether or not the user's trading history suggests that he or she will complete the trade once accepted, i.e. the trading reliability of person 3).
Characteristics, preferences and previous history of person 2.
Any relation or previous history connecting persons 2 and 3 (for example indicating that they know one another, e.g. are friends, belong to a shared group, e.g. a company, are geographically close to one another, or have previously traded with one another).
Characteristics, and previous history related to digital cameras (item 6) in general, e.g. being a relatively popular item, a digital camera may result in a relatively high weighting. On the other hand, a specific item of used women's clothing may result in a relatively low weighting.
Characteristics, and previous history related to mobile phones (item 3) in general.
Characteristics and related history of the particular digital camera (item 6) being traded, e.g. an unpopular brand may result in a lower weighting.
Characteristics and related history of the particular mobile phone (item 3) being traded.

When registering with the service, a user may record his or her static properties, e.g. location, sex, age, trading areas of interest etc. Alternatively, certain of this data may be acquired from a third party database or system. The data is used when calculating a weight for a directed edge involving that user. When the user enters an item into the database as a potential trade, as well as categorising that item the user may add further qualifications that can be used to determine an edge weight, e.g. possible wants. The step of determining a weight is repeated for every edge in the graph, resulting in a weighted graph. This graph is updated periodically (e.g. every 30 seconds) in order to include trades that are newly added to the database. The database may also be updated each time a new trade is added.

FIG. 4 illustrates one possible tabulated representation of the Have graph of FIG. 3, i.e. illustrating how the weighted graph may be maintained in a database. A row is included in the table for each item of each person, and for each such item one or more directed edges are included corresponding to the item(s)—and associated person—that may be released if a trade is made. For each item that may be released, an edge weight is given. In addition, for each item, one or more properties are included. For example, for item 1 of user 1, that is a TV, p1 might indicate that the TV is an LCD TV, whilst p2 indicates that the TV has a screen size of 20 inches.

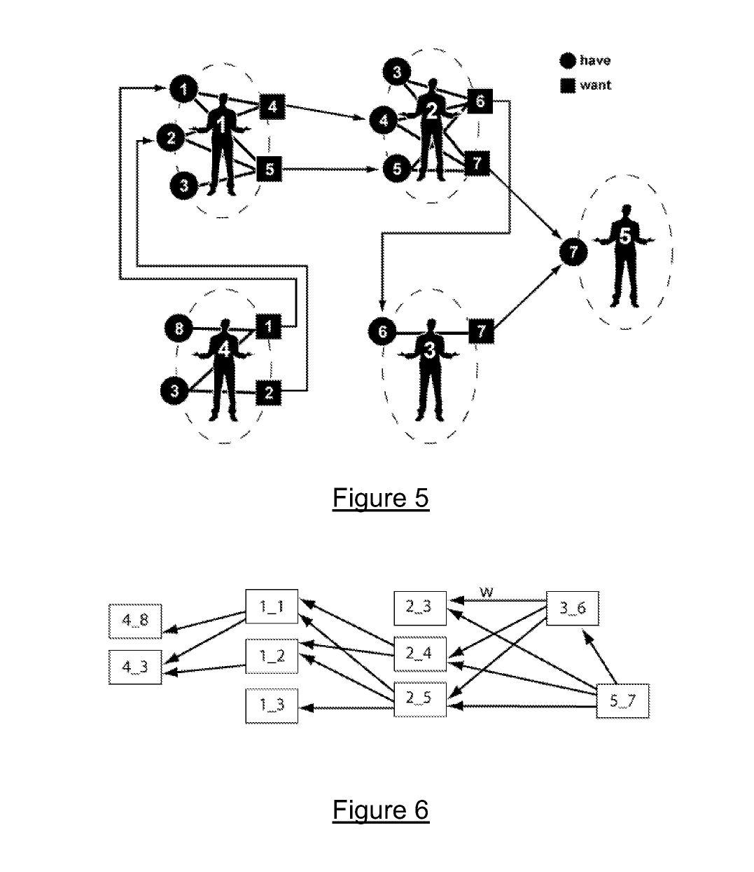

Consider a user (person 5) accessing the trading service website and having an item 7 (a table) to trade. The user inputs details of his item, including the item category (in this case “7”) and any further parameters. This input may be menu driven with the user selecting from categories and parameters displayed in a web browser window. At this stage the new user has not defined a Want. FIG. 5 illustrates the Have-Want diagram including the new user and his item. It will be apparent that the new user's Have matches a Want of persons 2 and 3. FIG. 6 illustrates the graph corresponding to the Have-Want diagram of FIG. 5. It will be further appreciated that, by giving away his item 7, person 5 would be able to obtain any one of the other items currently recorded in the database.

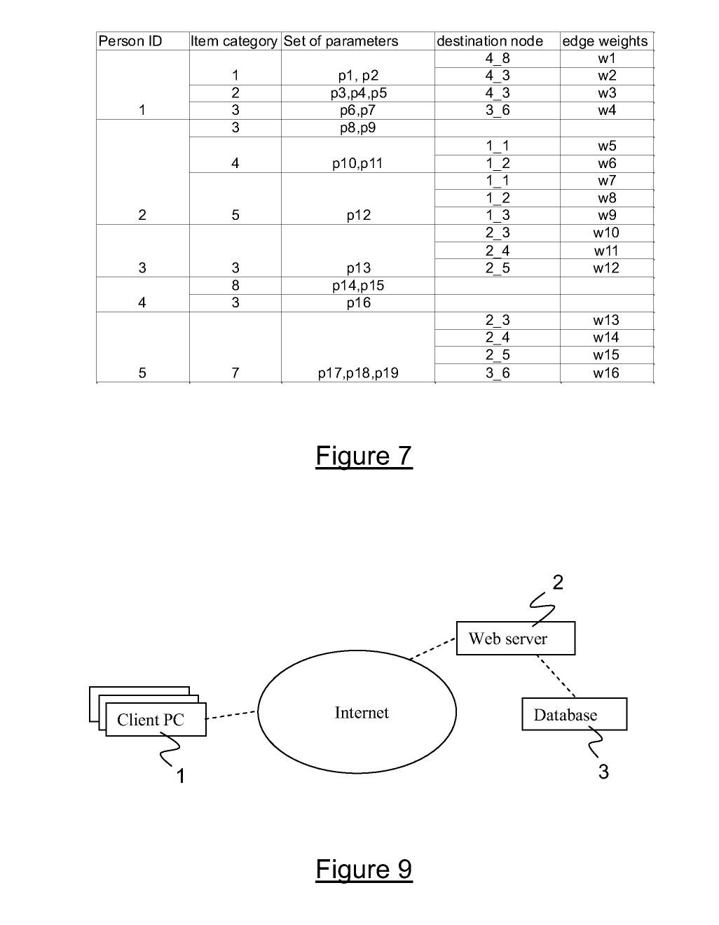

FIG. 7 shows the tabulated graph of FIG. 4 updated to include the new user. Weights have been calculated for all of the directed edges for which the Have of person 5 is the source object. As person 5 has not yet defined any Wants, Wants for person 5 do not appear in the destination node column.

Once the trading service has constructed the updated tabulated graph of FIG. 7, it is relatively straightforward to identify items that person 5 may obtain by giving away his item 7. Firstly, destination nodes matching 2-way trades are identified, namely (2_3), (2_4), (2_5), and (3_6). Secondly, using that first set of results, 3-way trades are identified, e.g. item (2_4) may be traded onwards to make items (1_1) and (1_2) available. Similarly, 4-way and 5-way trades are identified. For each item identified, a trade chain weight is determined. This might be a simple sum of the individual edge weights. So, for example, the weights for the 2-way trades will be as follows: {(2_3), w13}; {(2_4), w14}; {(2_5), w15}; {(3_6), w16}. For the 3-way trades, the weights will be: {(1_1), w14+w5}; {(1_2), w14+w6}, etc, and similarly for the 4-way and 5-way trades. The service returns the results to person 5′s computer for display in the web browser window. The results are ordered, by the service, according to the weighting, with the item (possible Want) having the lowest weighting appearing first and the item having the highest weighting appearing last. [Other ordering schemes are also possible.] A clear advantage of this approach is that the items appearing at or near the top of the results list (within the user's browser window) will correspond to those items that, for one reason or another, are desired by the user and/or are likely to result in a successful trade. If weights are indicative of revenue generation, that the advantage is that trades generating the highest revenue are likely to be selected ahead of those generating less revenue.

One approach to search the graph for available items is to follow each chain to the end, one at a time, as suggested in the previous paragraph. However, the results will be returned in a fairly random order in terms of their weights (except of course that the results for shorter chains may be returned ahead of those for longer chains). All results must be obtained before they can be ordered according to weighting and returned to the querying user's computer. A more optimal approach to searching the graph is to use a relevance search algorithm. One example is to use the Dijkstra's (shortest path) algorithm. Combined with proper weighting, this returns results in order of desirability, i.e. results having the lowest weights are returned ahead of those with higher weights. The results can be returned to the querying user's computer as they are generated, and there is no need to generate all results before reordering them at the web site server.

The results list may still however be relatively long for a large trade database. Therefore, the information presented in the user's browser window include options to refine the search so as to reduce the number of “hits”. This may include a list of general categories such as; “Babies & kids”, “Books & magazines”, “Building & renovation”, etc. By selecting one of these categories, the user causes the service to filter (at the web server) the result list to include only those items matching the selected category. The filtered result list is returned to the user's computer and presented in the web browser window. Again, the filtered result list is ordered according to the trade chain weights. Selecting one category may result in the display of a plurality of sub-categories within the browser window. Similarly, the information in the browser window may include a free text search box. When the user enters a term or terms into this box and submits the request to the service, the service again filters the result list to include only those items matching the search query.

A user may include multiple Haves in a search of the service database. The service may return the results ordered by weighting alone, or using a combination of weighting and item category/parameter.

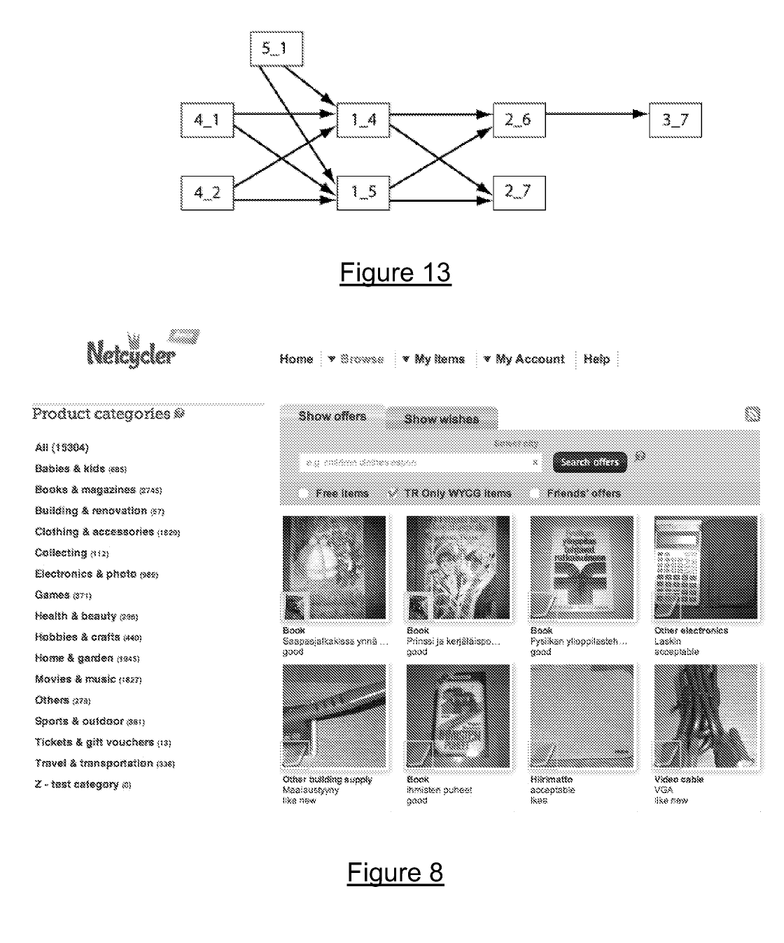

Results displayed in a browser window may include a brief description of each available item as well as a thumbnail image if one has been submitted. The display may be enhanced by including as an inset within each such thumbnail, a further smaller thumbnail image showing the Have that the user must give away in order to obtain the particular offered item. This display approach is particularly useful when the user has entered a number of Haves into the system. This is illustrated in FIG. 8.

It will be appreciated that a tabulated graph approach to storing data is easily usable to identify closed chains matching to both a Have and a Want of a given user. In this case, referring for example to FIG. 7, all possible Haves could be identified based upon the users specified Want, and the results filtered to identify only those possible Haves matching the actual Have of the user. Again, the weight for each resulting closed chain can be calculated, and the results displayed in the users web browser window with the result having the lowest weight shown first. More sophisticated approaches to identifying closed chains may of course be employed.

FIG. 9 illustrates schematically a network architecture over which the above described mechanism may be implemented. A plurality of client PCs 1 are coupled to the Internet (of course other Internet connected devices such as smartphones may be employed). The trading service is implemented on a web server (or set of web servers) 2. The web server implements in particular the graph generation and searching function. Item data is stored on a database 3. Other architectures are also possible, including one where the graph generation is performed in a server separate from the web server 2.

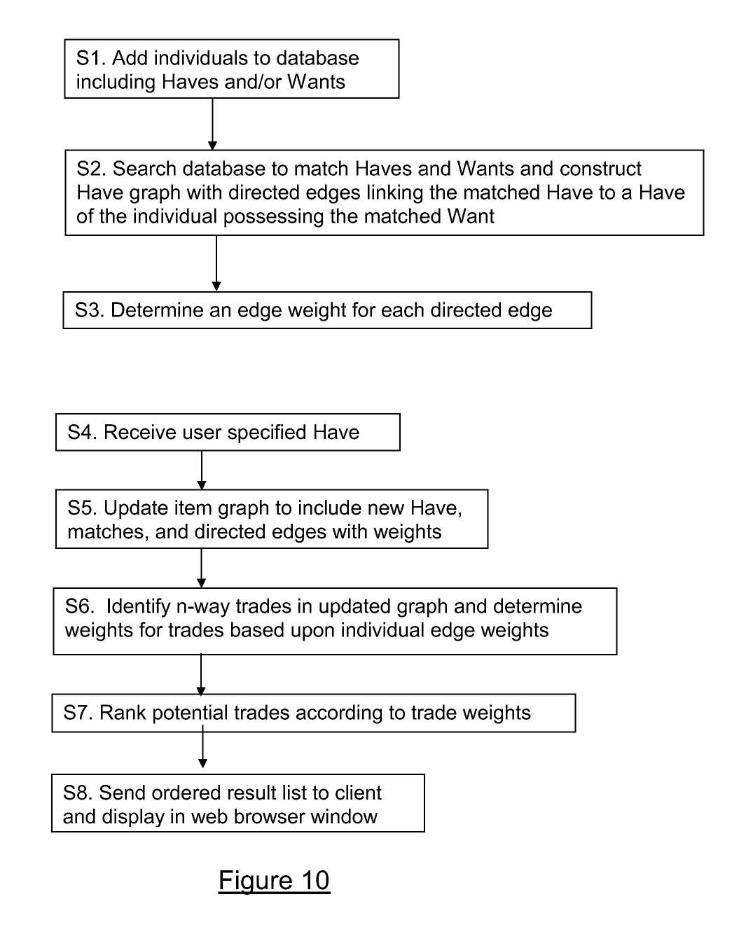

FIG. 10 is a flow diagram further illustrating the trading system described above. The process comprises a first series of steps S1 to S3 to established the weighted Have graph. This process is repeated at regular intervals to refresh the graph. Step S1.

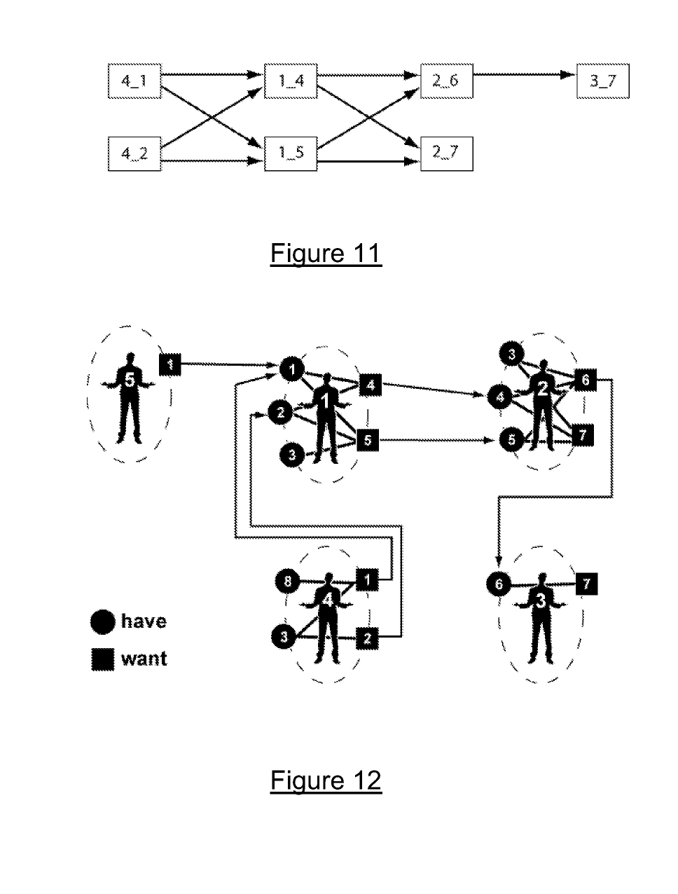

FIGS. 11 to 13 illustrate an alternative approach to implementing a trading system. Rather than being based upon users' Haves, this alternative approach relies principally upon users' wants. Thus, FIG. 11 illustrates a directed graph showing users wants (based upon the Have/Want database illustrated in FIG. 2). For example, it shows that user 4 possess an item 1, denoted item (4_1), and that if this want is satisfied, this will directly result in wants becoming available for items (1_4) and (1_5), and indirectly in wants becoming available for items (2_6), (2_7) and (3_7). FIG. 11 illustrates a scenario where a new user, person 5, comes to the service, and that this new user indicates a want for item 1. FIG. 13 shows the graph of FIG. 10 updated to include this new want, denoted as item (5_1). It will be appreciated that a tabulated graph, along the lines of FIG. 7 can be constructed, but with rows in the graph corresponding to user Wants rather than user Haves.

The approach illustrated in FIGS. 11 to 13 make it possible for users to search the web service on the basis of a Want rather than a Have. A user may enter details of a Want into a search box in his or her web browser window, and the service will search the Want graph to identify trade chains starting with this want in order to identify items wanted by other users that would allow the new user's want to become available to him or her. Again, the results are weighted and displayed accordingly to the user. The Want-based approach of FIGS. 11 to 13 may be combined with the Want-based approach described above in a single integrated trading service.

It will be appreciated by the person of skill in the art that various modifications may be made to the above described embodiments without departing from the scope of the present invention. For example, the embodiments described above propose calculating a trade weight by adding together the various edge weights. Other trade weight generation functions may be used. For example, where an edge weight represents a probability, the trade weight may be the product of the various edge weights. Weights may be determined based upon factors other than the likelihood or probability of a trade. For example, a weight may be indicative of the CO2 emissions arising from a trade (due to shipping costs) or of the revenue generated for the service provider and/or the trading parties.

1. A method of identifying potential trades within a database holding details of individuals and items that these individuals are willing to give away, “Haves”, and/or to receive, “Wants”, the method comprising:
1) searching said database to identify matching Haves and Wants and, for each such match, defining a directed edge linking the matched Have to a Have of the individual possessing the matched Want;
2) determining an edge weight for the directed edge defined for each match;
3) for one of said individuals possessing a Have, identifying potential n-way trades for the individual by identifying a directed edge or directed edges originating at the individual's Have and/or by connecting two or more directed edges including at least a directed edge originating at the individual's Have, where n is an integer greater than 1;
4) for each potential trade, determining a trade weight on the basis of the or each associated link weight; and
5) ranking the potential trades according to the respective trade weights.

2. A method according to claim 1, wherein step 4) is conducted as part of step 3) such that a trade weight for an n-way trade is determined as the trade is constructed using one or more directed edges.

3. A method according to claim 2, wherein the ranking of step 5n) arises from the order in which n-way trades are identified in step 3), n-way trades being identified in order according to their trade weights.

4. A method according to claim 1, wherein step 3) comprises using a Dijkstra search to identify and rank n-way trades.

5. A method according to claim 1 and comprising performing steps 1) to 5) at a web server connected to the Internet, the method further comprising receiving at the web server from a client computer, a submission from an individual identifying a Have of that individual, including the Have into said database and repeating steps 1) and 2) to take account at least of the updated data, performing steps 3) to 5) to identify and rank potential trades including the Have identified in the submission, and returning a list of potential trades to the client computer ordered according to the ranking.

6. A method according to claim 5, wherein the ranking of step 5) arises from the order in which n-way trades are identified in step 3), n-way trades being identified in order according to their trade weights and comprising sending the identified trades from the web server to the client computer in the order in which they are identified, receiving the identified trades at the client computer, and displaying the trades in a web browser window in the order of receipt.

7. A method according to claim 5, wherein said database includes for all items held in the database one or more properties, wherein the submission includes or is accompanied by one or more properties associated with an unspecified Want of the submitting individual, and step 3) comprises identifying only those n-way trades that result in a Have possessing the one or more properties associated with the unspecified Want.

8. A method according to claim 1, wherein step 2) comprises determining an edge weight for a directed edge on the basis of a property or properties of at least one of the items associated with the directed edge.

9. A method according to claim 8, wherein a said property of an item is a trading history of the item or of similar items.

10. A method according to claim 1, wherein step 2) comprises determining an edge weight for a directed edge on the basis of a property or properties of at least one of the individuals associated with the directed edge.

11. A method according to claim 10, wherein a said property of an individual is one of:
a trading history of the individual;
a geographical location of the individual; and
a group membership of the individual or a relationship of the individual with another individual identified in the database.

12. A method according to claim 1 and comprising repeating steps 1) and 2) at regular time intervals in order to take account of Haves and Wants newly added to the database.

13. A method according to claim 1, where said weight is indicative of the likelihood of a successful trade involving the matched items.

14. A method according to claim 1 and comprising, at step 3), identifying a Want of said individual, and identifying only potential n-way trades that result in a closed trade chain.

15. A computer programmed to carry out the method of claim 1.

16. A method of identifying potential trades within a database holding details of individuals and items that these individuals are willing to give away, “Haves”, and/or to receive, “Wants”, the method comprising:
1) searching said database to identify matching Wants and Haves and, for each such match, defining a directed edge linking the matched Want to a Want of the individual possessing the matched Have;
2) determining an edge weight for the directed edge defined for each match;
3) for one of said individuals possessing a Want, identifying potential n-way trades for the individual by identifying a directed edge or directed edges originating at the individual's Want and/or by connecting two or more directed edges including at least a directed edge originating at the individual's Want, where n is an integer greater than 1;
4) for each potential trade, determining a trade weight on the basis of the or each associated link weight; and
5) ranking the potential trades according to the respective trade weights.

17. A method of presenting a plurality of possible trade results to a user, the results having been generated following the submission of details of a plurality of items by the user to an online trading web service, these submitted items being items that the user is willing to give away, the method comprising:
displaying within a web browser window presented on a display of a user computer, an ordered set of result images depicting respective items that the user may obtain by trading one of the submitted items; and
within each said result image, displaying as an inset an image depicting the submitted item that the user must give away in order to obtain the item displayed in the associated result image.

18. A method according to claim 5, wherein step 3) comprises using a Dijkstra search to identify and rank n-way trades, and comprising sending the identified trades from the web server to the client computer in the order in which they are identified, receiving the identified trades at the client computer, and displaying the trades in a web browser window in the order of receipt.
